(19) United States
(12) Patent Application Publication
(10) Pub. No.: US 2025/0278690 A1
(43) Pub. Date: Sep. 4, 2025

(54) SHIPPING MANAGEMENT DEVICE, SALES MANAGEMENT DEVICE, SHIPPING MANAGEMENT METHOD, SALES MANAGEMENT METHOD, AND RECORDING MEDIUM

(71) Applicant: Rakuten Group, Inc., Tokyo (JP)

(72) Inventors: Masatoshi KINAMI, Tokyo (JP); Rie NAKATANI, Tokyo (JP)

(73) Assignee: Rakuten Group, Inc., Tokyo (JP)

(21) Appl. No.: 19/068,094

(22) Filed: Mar. 3, 2025

(30) Foreign Application Priority Data
Mar. 4, 2024 (JP) 2024-032443

(51) Int. Cl. G06Q 10/083; G06Q 10/0875

(52) U.S. Cl. CPC G06Q 10/083; G06Q 10/0875

(57) ABSTRACT

A shipping management device includes a receiver that receives, from a sales management device, a first shipping request in which a first item and a first shipping count are specified; a determiner that determines a first processing deadline in accordance with a first received date and time at which the first shipping request is received; an outputter that outputs a first command indicating that the first shipping count is to be shipped from the inventory of the first item by the determined first processing deadline; a reception unit that, when the outputted first command cannot be fulfilled due to an actual inventory count being less than the specified first shipping count, receives a failure report, including the actual inventory count, from a user; and a sender that sends, to the sales management device, a first failure response expressing the actual inventory count related to the received failure report and that the processing of the first shipping request has failed.

### CROSS-REFERENCE TO RELATED APPLICATIONS

This application claims the benefit of Japanese Patent Application No. 2024-32443, filed on Mar. 4, 2024, the entire disclosure of which is incorporated by reference herein.

### FIELD OF THE INVENTION

The present disclosure relates generally to a shipping management device, a sales management device, a shipping management method, a sales management method, and a recording medium.

### BACKGROUND OF THE INVENTION

In warehouses managed by vendors such as stores, sellers, manufacturers, and the like, warehouse management systems are known that manage shipping processing of items from the warehouse. For example, in the warehouse management system disclosed in Unexamined Japanese Patent Application Publication No. 2022-164206, a user that is a vendor sends, to a warehouse management server via a user terminal, a shipping request for shipping a desired package, and causes a delivery machine to deliver that package.

### SUMMARY OF THE INVENTION

Inventory counts of items in the warehouse are managed by the vendor that is the requester of the shipping request and, as such, typically, there should not be cases in which a shipping request cannot be fulfilled due to insufficient inventory. However, there are various situations in which inventory may be insufficient such as when an item or packaging thereof is damaged in the warehouse, an item is lost, and the like.

When inventory is insufficient, a worker in the warehouse reports the situation to the requester vendor, and, for that item, the vendor that receives the report considers and determines whether to ship only a portion of the desired number of items or to cancel the shipping entirely.

The present disclosure is made with the view of the above situation, and an objective of the present disclosure is, when an item in a warehouse has insufficient inventory, to assist the smooth and expedited performance of processing for shipping only a portion of the desired number of items.

A brief explanation of the main features of the representative embodiments disclosed in the present application is as follows. A shipping management device according to a first aspect of the present embodiment is a shipping management device connected to a sales management device via a network, the shipping management device comprising:
one or more processors, wherein
the one or more processors
   receive, from the sales management device, a first shipping request in which a first item and a first shipping count are specified,
   determine a first processing deadline in accordance with a first received date and time at which the first shipping request is received,
   output a first command indicating that the first shipping count is to be shipped from an inventory of the first item by the determined first processing deadline,
   in a case in which the first command cannot be fulfilled due to the actual inventory count being less than the specified first shipping count,
      receive, from a user, a failure report including the actual inventory count and
      send, to the sales management device, a first failure response expressing the actual inventory count related to the received failure report and that processing of the first shipping request has failed, and
   in a case in which the one or more processors receive, from the sales management device, a second shipping request in response to the first failure response, the first item and a second shipping count less than or equal to the actual inventory count being specified in the second shipping request,
      the one or more processors set a second processing deadline to match the first processing deadline in cases in which a time margin from a second received date and time at which the second shipping request is received to the determined first processing deadline is longer than a predetermined reference, and set the second processing deadline to the second received date and time in cases in which the time margin is not longer than the predetermined reference, and
      the one or more processors outputs a second command indicating that the second shipping count is to be shipped from the inventory of the first item by the set second processing deadline.

A sales management device according to a second aspect of the present embodiment is a sales management device connected to a shipping management device via a network, the sales management device comprising:
one or more processors, wherein
the one or more processors
   receive, from a user, a first shipping request in which a first item and a first shipping count are specified,
   send, to the shipping management device, the received first shipping request, and
   receive, from the shipping management device, a first failure response expressing an actual inventory count that is less than the specified first shipping count and that processing of the first shipping request has failed,
the one or more processors further receive, from a user, a second shipping request in response to the received first failure response, the first item and a second shipping count less than or equal to the actual inventory count being specified in the second shipping request, and
the one or more processors further send the received second shipping request to the shipping management device.

According to the present disclosure, when an item in a warehouse has insufficient inventory, it is possible to assist the smooth and expedited performance of processing for shipping only a portion of the desired number of items.

### BRIEF DESCRIPTION OF DRAWINGS

A more complete understanding of this disclosure can be obtained when the following detailed description is considered in conjunction with the following drawings, in which:

FIG. 1 is an explanatory drawing illustrating the linking between a shipping management device and a sales management device according to an embodiment;

FIG. 2 is an explanatory drawing illustrating the functional configuration of the shipping management device according to the embodiment;

FIG. 3 is an explanatory drawing illustrating the functional configuration of the sales management device according to the embodiment;

FIG. 4 is a sequence drawing illustrating the exchange between the shipping management device and the sales management device according to the embodiment;

FIG. 5 is an explanatory drawing illustrating an example of an output command screen according to the embodiment;

FIG. 6 is an explanatory drawing illustrating an example of a failure report screen displayed by the shipping management device according to the embodiment;

FIG. 7 is an explanatory drawing illustrating an example of a failure report screen output by the sales management device according to the embodiment;

FIG. 8 is an explanatory drawing illustrating an example of a re-request screen according to the embodiment;

FIG. 9 is a flowchart explaining the flow of shipping management processing according to the embodiment;

FIG. 10A is an explanatory drawing illustrating an example of a shipping request table according to the embodiment;

FIG. 10B is an explanatory drawing illustrating the content of the status in the shipping request table according to the embodiment;

FIG. 11 is a flowchart explaining the flow of sales management processing according to the embodiment;

FIG. 12 is a flowchart explaining the flow of shipping management processing according to a modified example;

FIG. 13 is a flowchart explaining the flow of layaway determination processing according to a modified example; and

FIG. 14 is an explanatory drawing illustrating an example of an item table T2 according to a modified example.

### DETAILED DESCRIPTION OF THE INVENTION

### Relationship Between Shipping Management Device, Sales Management Device, and Program

A shipping management device and a sales management device according to the present embodiment are configured by a computer such as a smartphone, a tablet computer, a personal computer, or the like. The shipping management device and the sales management device are connected by a network such as the Internet or the like.

The shipping management device is a device that is used by a user such as a worker, manager, or the like in a warehouse, and manages, on the basis of shipping requests, shipping processing for shipping items stored in the warehouse. The sales management device is a device used by a vendor such as a store, a distributor, a manufacturer, or the like, and sends, to the shipping management device of the warehouse in which the items managed by the vendor are stored, shipping requests for shipping desired items.

The shipping management device and the sales management device of the present embodiment are typically realized by causing computers to execute programs, but the shipping management device and the sales management device can also be realized by causing dedicated electronic circuits to execute processings.

In addition, as an intermediate form between a computer and a dedicated electronic circuit, the shipping management device and the sales management device of the present embodiment can each be configured by compiling a program in the design script of an electronic circuit and applying a field programmable gate array (FPGA) or similar technology that dynamically configures the electronic circuit on the basis of that design script.

The shipping management device and the sales management device according to the present embodiment are each realized by one or a plurality of computers executing various functions that are realized by one or a plurality of programs.

Typically, the programs executed by the shipping management device and the sales management device can be recorded on a non-transitory computer-readable information recording medium such as a compact disk, a flexible disk, a hard disk, a magneto-optical disk, a digital video disk, a magnetic tape, read-only memory (ROM), electrically erasable programmable ROM (EEPROM), flash memory, and semiconductor memory. This non-transitory information recording medium can be distributed/sold separate from the shipping management device and the sales management device.

In the shipping management device and the sales management device, the programs stored on the non-transitory information recording medium such as a flash memory, a hard disk, or the like are read out to random access memory (RAM), which is a temporary storage device, and, then, commands included in the read-out programs are executed by a central processing unit (CPU). However, in architectures in which the RAM and the ROM can be mapped to a single memory space and execution is possible, the commands included in the programs stored in the ROM are read out and executed directly by the CPU.

Furthermore, the program for realizing the shipping management device or the sales management device can be distributed to the computers or sold from a distribution server or the like managed by a business or an operator, via a temporary transmission medium such as a computer communication network, separate from the computer on which the program is to be executed.

Note that, when the shipping management device or the sales management device is configured from a plurality of computers, the programs running on the various computers are a plurality of mutually different programs that cooperate with each other while having mutually different functions. As such, the combination of this plurality of programs can be regarded as a system program for realizing the shipping management device or the sales management device.

In the following, in the present embodiment, a user that is an employee of a vendor or the like uses the sales management device to send, to the shipping management device of the warehouse in which items are stored, a shipping request for shipping the items to a desired destination. The shipping management device outputs the shipping request received from the sales management device and, when, for some reason, an inventory count of the item is insufficient and the shipping request cannot be fulfilled, sends a notification indicating such to the sales management device.

### Overall Configuration

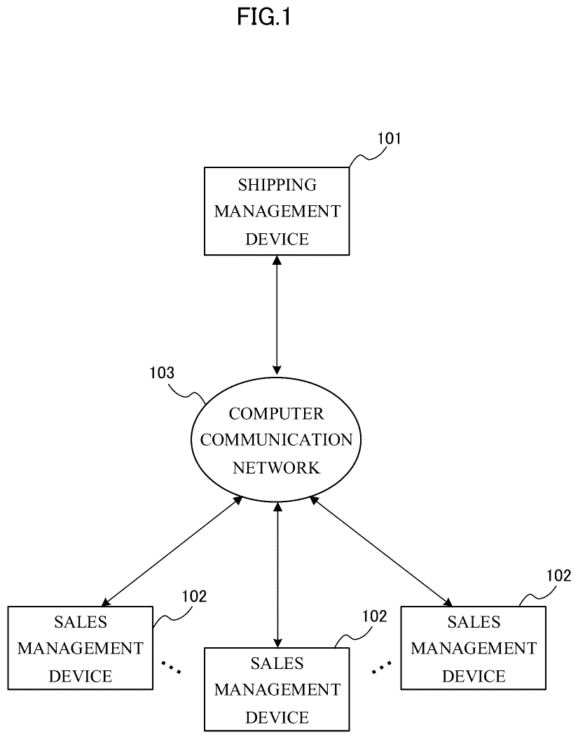

FIG. 1 is an explanatory drawing illustrating the linking between a shipping management device 101 and a sales management device 102. Hereinafter, a description is given while referencing FIG. 1.

The shipping management device 101 is connected to one or more of the sales management device 102 via a computer communication network 103 such as the Internet. The shipping management device 101 is used by a warehouse user such as a worker, a manager, or the like in a warehouse. The shipping management device 101 outputs a shipping request that is sent from the sales management device 102 via the computer communication network 103 for the shipping work of the warehouse user, receives, from the warehouse user, a report when the shipping request cannot be fulfilled, and sends a notification indicating such to the sales management device 102.

The sales management device 102 is used by a vendor user that is an employee or the like of the vendor. The sales management device 102 sends, to the shipping management device 101, a shipping request received from the vendor user and, when a notification is received from the shipping management device 101 indicating that the shipping request cannot be fulfilled, presents a notification indicating such to the vendor user.

### Functional Configurations of Shipping Management Device and Sales Management Device

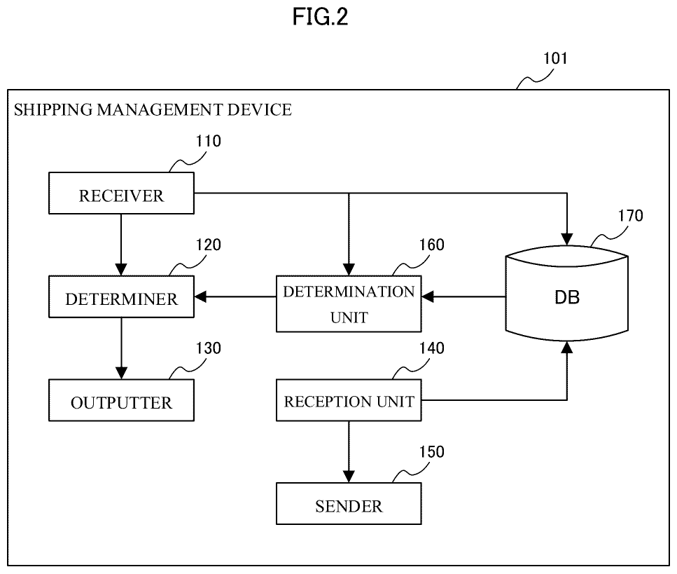

FIG. 2 is an explanatory drawing illustrating the functional configuration of the shipping management device 101. The shipping management device 101 includes a receiver 110, a determiner 120, an outputter 130, a reception unit 140, a sender 150, a determination unit 160, and a database (DB) 170.

The receiver 110 receives a first shipping request and a second shipping request from the sales management device 102. In the shipping requests sent from the sales management device 102, an item to be shipped, a shipping count of that item, a destination to which the item is to be shipped, a requester name, details of a shipping method, and the like are specified. The information other than the item and the shipping count are omitted in the shipping requests of the present embodiment.

Here, the first shipping request is a new shipping request. A first item and a first shipping count are specified in the first shipping request. The second shipping request is a re-shipping request that is sent from the sales management device 102, and is a shipping request in response to a first failure response described layer. The first item and a second shipping count are specified in the second shipping request.

The determiner 120 determines a first processing deadline in accordance with a first received date and time at which the first shipping request is received. Additionally, the determiner 120 determines a second processing deadline in accordance with a second received date and time at which the second shipping request is received. The first processing deadline and the second processing deadline are deadlines by which the warehouse user is to process the first shipping request or the second shipping request and, in one example, are deadlines by which procedures for shipping the first shipping count or the second shipping count of the first item or a second item are to be completed.

The outputter 130 outputs a first command indicating that the first shipping count is to be shipped from the inventory of the first item by the first processing deadline determined by the determiner 120. Additionally, the outputter 130 outputs a second command indicating that the second shipping count is to be shipped from the inventory of the first item by the second processing deadline determined by the determiner 120. Examples of the mode of outputting the first command or the second command include displaying on a monitor of the shipping management device 101, and printing from a printer that is wiredly or wirelessly connected to the shipping management device 101.

When the first command output by the outputter 130 cannot be fulfilled due to an actual inventory count being less than the first shipping count, the reception unit 140 receives a failure report, including the actual inventory count, from the warehouse user.

The sender 150 sends, to the sales management device 102, a first failure response expressing the actual inventory count related to the failure report received by the reception unit 140 and that the processing of the first shipping request has failed.

The determination unit 160 determines whether the second shipping request is in response to the first failure response. In addition to the item, the shipping count, and the like described above, the shipping request may include a request ID that identifies the shipping request, and the determination unit 160 may determine that the second shipping request is in response to the first failure response when the request ID of the first shipping request and the request ID of the second shipping request match.

The DB 170 stores a shipping request table T1 and an item table T2. Detailed information related to the shipping requests received from the sales management device 102 is registered in the shipping request table T1. Detailed information related to the items stored in the warehouse is registered in the item table T2. These tables are described in detail later.

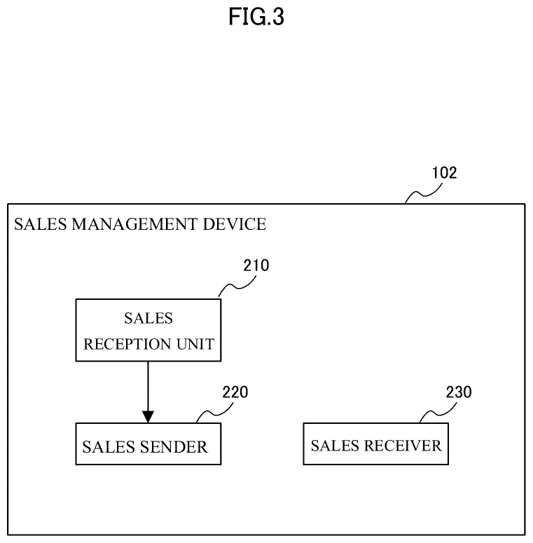

FIG. 3 is an explanatory drawing illustrating the functional configuration of the sales management device 102. The sales management device 102 includes a sales reception unit 210, a sales sender 220, and a sales receiver 230.

The sales reception unit 210 receives, from the vendor user, the first shipping request or the second shipping request.

The sales sender 220 sends, to the shipping management device 101, the first shipping request or the second shipping request received by the sales reception unit 210.

The sales receiver 230 receives the first failure response from the shipping management device 101.

### Exchange Between Shipping Management Device and Sales Management Device

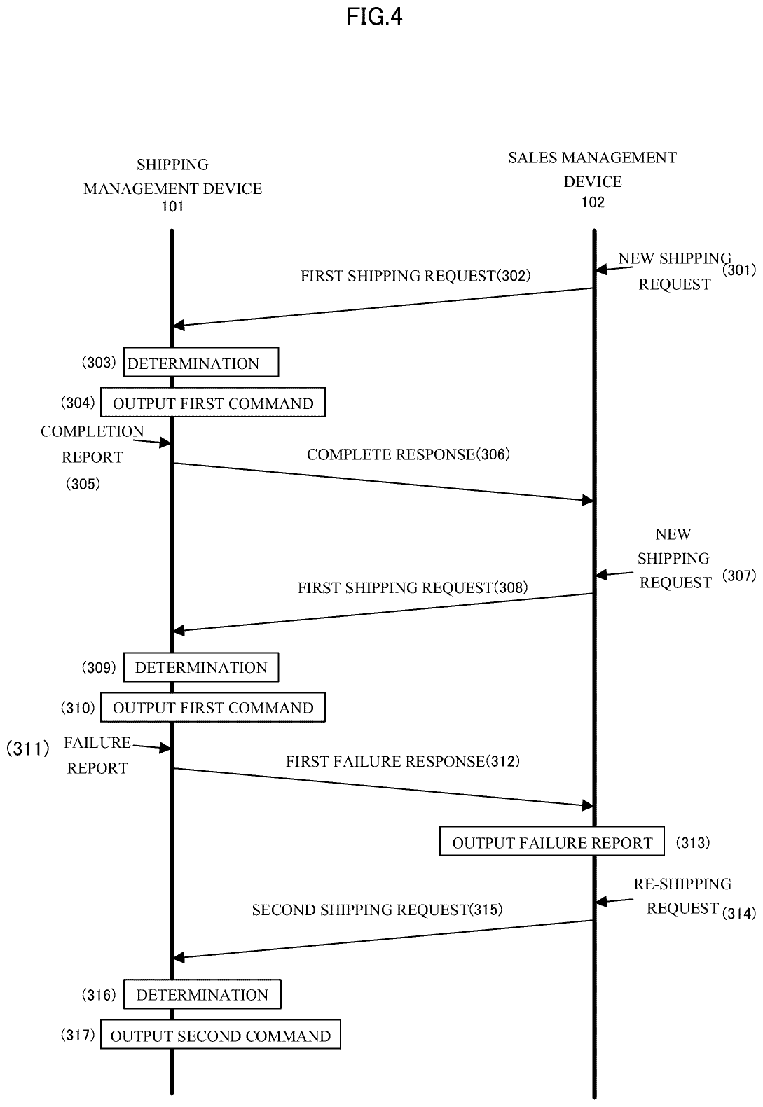

FIG. 4 is a sequence drawing illustrating the exchange between the shipping management device 101 and the sales management device 102. Hereinafter, an overview of the exchange between the shipping management device 101 and the sales management device 102 is described while referencing FIG. 4.

Firstly, an example of the exchange in a case in which a shipping request sent from the sales management device 102 is completed without issues is described. When the sales reception unit 210 of the sales management device 102 receives a new shipping request from the vendor user in which an item and a shipping count are specified (301), the sales sender 220 sends, to the shipping management device 101, a first shipping request in which the first item and the first shipping count are specified (302).

When the receiver 110 of the shipping management device 101 receives the first shipping request from the sales management device 102, the determiner 120 determines the first processing deadline in accordance with the first received date and time at which the first shipping request is received (303). Then, the outputter 130 outputs the first command indicating that the first shipping count of the first item is to be shipped by the first processing deadline (304).

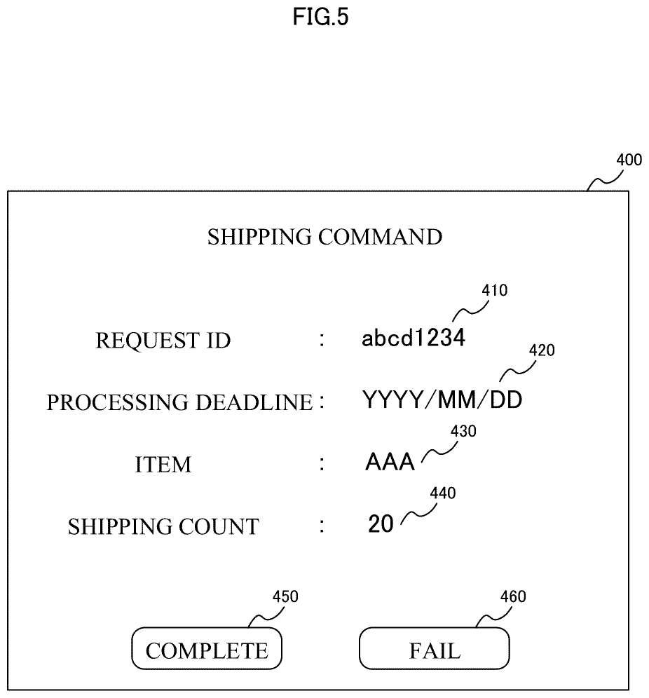

A shipping command screen output by the outputter 130 is as illustrated in the example of FIG. 5. A request ID 410, a processing deadline (first processing deadline) 420, an item (first item) 430, and a shipping count (first shipping count) 440 are included in the output command screen (first output command) 400, and a complete button 450 and a fail button 460 are displayed. The complete button 450 is a button that is selected when the warehouse user completes the first shipping request commanded by the first output command. The fail button 460 is a button that is selected when the warehouse user cannot complete the first shipping request due to a reason such as insufficient inventory or the like.

Returning to FIG. 4, when the warehouse user completes the first shipping request and selects the complete button 450 (305), the sender 150 sends, to the sales management device 102, a complete response indicating that the processing of the first shipping request is complete (306). Thus, the shipping request sent from the sales management device 102 is completed.

Next, an example of the exchange in a case in which a shipping request sent from the sales management device 102 fails is described. The flow up to when the sales reception unit 210 of the sales management device 102 receives the new shipping request from the vendor user (307) and the shipping management device 101 outputs the first output command (310) is the same as the flow of (301) to (304).

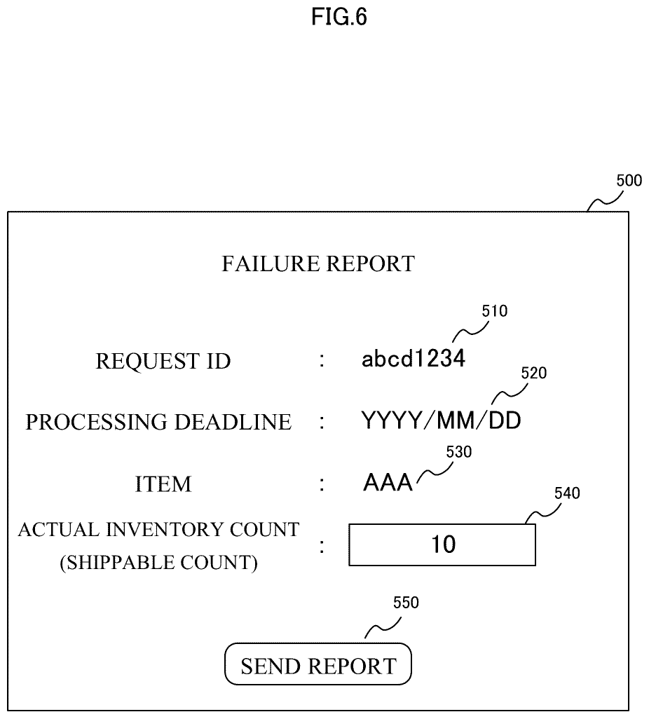

Transitioning to FIG. 5, when the warehouse user selects the fail button 460 of the shipping command screen 400 upon realization that the first shipping command 400 cannot be fulfilled due to insufficient inventory of the first item 430 indicated in the first shipping command 400, a failure report screen 500 illustrated in the example of FIG. 6 is displayed. A request ID 510, a processing deadline (first processing deadline) 520, an item (first item) 530, and an input field for an actual inventory count (shippable count) 540 are included in the failure report screen 500, and a send report button 550 is displayed. The request ID 510, the processing deadline 520, and the item 530 may, as illustrated in the example of FIG. 6, be displayed in a non-editable manner, or may be displayed in input fields so as to be editable by the warehouse user.

When, as the failure report, the warehouse user inputs the actual inventory count 540 and selects the send report button 550 (311), the sender 150 sends, to the sales management device 102, a first failure response expressing the actual inventory count 540 and the other information included in the failure report, and that the processing of the first shipping request has failed (312).

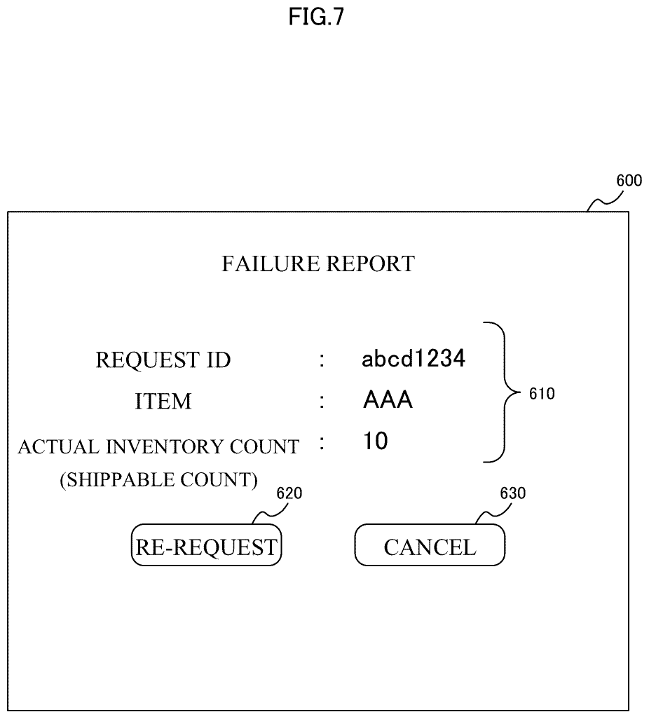

When the sales receiver 230 of the sales management device 102 receives the first failure response from the shipping management device 101, a failure report screen 600 illustrated in the example of FIG. 7 is output (313). Information 610 of the failure report expressed in the first failure response sent from the shipping management device 101 is included in the failure report screen 600, and a re-request button 620 and a cancel button 630 are displayed. The re-request button 620 is a button that the vendor user selects when confirming the failure report and, as a result of consideration, decides to perform a re-request. The cancel button 630 is a button that the vendor user selects when canceling the shipping request.

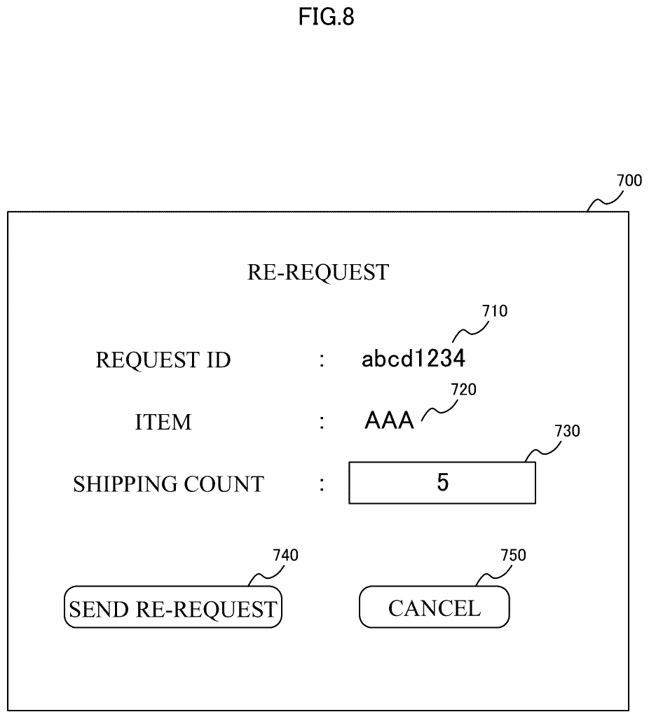

When the vendor user selects the re-request button 620, a re-request screen 700 illustrated in the example of FIG. 8 is displayed. A request ID 710, an item (first item) 720, and an input field 730 for the shipping count (second shipping count) are included in the re-request screen 700, and a send re-request button 740 and a cancel button 750 are displayed.

When, as a re-shipping request, the vendor user inputs a desired shipping count in the shipping count input field 730 and selects the send re-request button 740 (314), the sales management device 102 sends, to the shipping management device 101, the second shipping request in which the first item and the second shipping count are specified (315). Note that, when the vendor user does not perform a re-shipping request, it is sufficient to select the cancel button 750.

When the receiver 110 of the shipping management device 101 receives the second shipping request from the sales management device 102, the determiner 120 determines the second processing deadline in accordance with the second received date and time at which the second shipping request is received (316). Then, the outputter 130 outputs the second command indicating that the second shipping count of the first item is to be shipped by the second processing deadline (317). The warehouse user proceeds and executes the shipping processing in accordance with the content of the shipping command screen output by the outputter 130.

### Shipping Management Processing

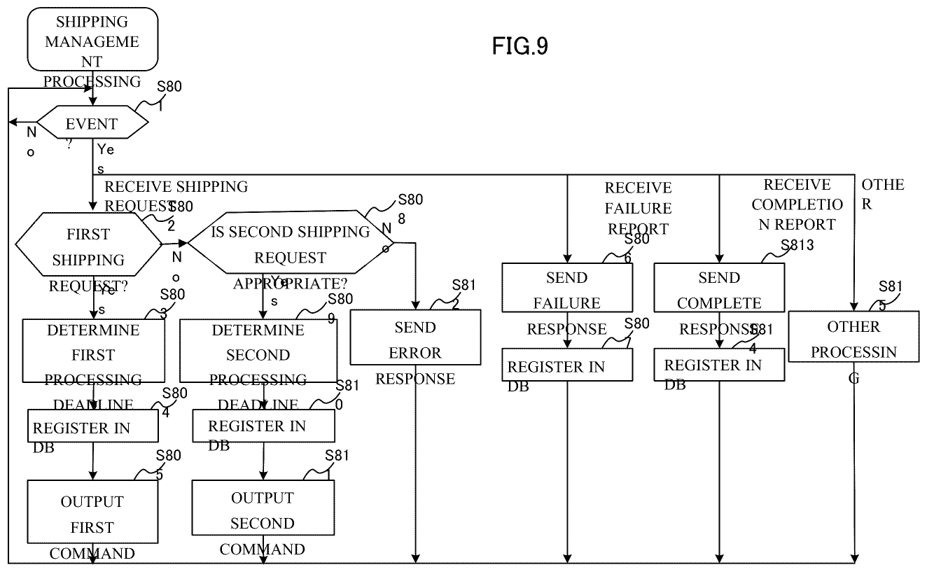

FIG. 9 is a flowchart explaining the flow of shipping management processing executed by the shipping management device 101. The shipping management device 101 presents, to the warehouse user, shipping commands in accordance with shipping requests sent from the vendor user via the sales management device 102 and, when the warehouse user cannot fulfill a shipping request, sends a notification indicating such to the sales management device 102. Hereinafter, a description is given while referencing FIG. 9.

In one example, the shipping management processing starts when the power of the shipping management device 101 is turned ON. When the shipping management processing starts, the shipping management device 101 determines if an event has occurred (step S801). The shipping management processing assumes a stand-by state until an event occurs (step S801; No).

Firstly, when the receiver 110 of the shipping management device 101 receives a shipping request (step S801; Yes), the receiver 110 registers the request ID, the received date and time, the item, and the shipping count in the shipping request table T1 stored in the DB 170. Here, in one example, this information is registered in row number #1 of the shipping request table T1.

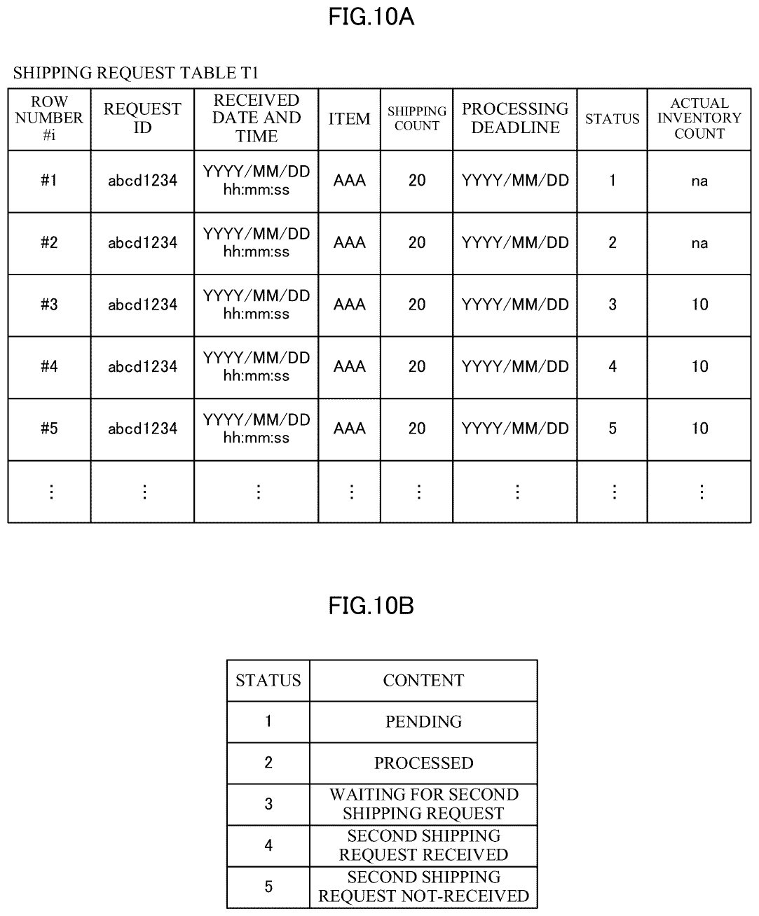

FIG. 10A is an explanatory drawing illustrating an example of the shipping request table T1. The shipping request table T1 includes, for every shipping request, a row number #i, a request ID, a received date and time, an item, a shipping count, a processing deadline, a status, and a shippable count. The row number #i indicates the row number of the shipping request table T1. The request ID is the request ID of the shipping request specified by the sales management device 102. The received date and time is the date and time at which the shipping request is received. The item is the item specified by the shipping request. The shipping count is the shipping count of the item specified by the shipping request. The processing deadline is the processing deadline determined by the determiner 120 of the shipping management device 101. The status indicates a current state of the shipping request. The shippable count indicates the actual inventory count 540 input by the warehouse user via the failure report screen 500.

Details of the status indicating the current state of the shipping request are as in the example illustrated in FIG. 10B. Status “1” indicates a “pending” state, which is a state from when the shipping request is received to when processing by the warehouse user is completed. Status “2” indicates a “processed” state, which is a state in which the processing by the warehouse user is completed. Status “3” indicates a “waiting for second shipping request” state, which is a state after the first failure response is sent to the sales management device 102 until when the second shipping request is received. Status “4” indicates a “second shipping request received” state, which is a state after the second shipping request has been received from the sales management device 102. Status “5” indicates a “second shipping request not-received” state, which is a state in which a predetermined amount of time has elapsed, after the first failure response is sent to the sales management device 102, without the second shipping being received. During a period after the first failure response has been sent to the sales management device 102 and before the second shipping request is received, the status is “3” until the predetermined amount of time elapses, and the status is changed to “5” when the predetermined amount of time elapses.

Returning to step S801 of FIG. 9, the state of the shipping request received by the receiver 110 is the pending state and, as such, the receiver 110 stores the status “1” in the record of row number #1.

Next, the determination unit 160 references the shipping request table T1 and determines if the received shipping request is a first shipping request or a second shipping request (step S802). Specifically, the determination unit 160 references the shipping request table T1 stored in the DB 170 and determines whether the request ID included in the received shipping request matches, among shipping requests received in the past, the request ID of a shipping request for which the status is “3”, that is, the status is the “waiting for second shipping request” state. When the determination unit 160 determines that the request ID included in the received shipping request matches the request ID of a shipping request received in the past for which the status is “3”, the determination unit 160 determines that the received shipping request ID is a first shipping request (step S802; Yes). Meanwhile, when the determination unit 160 determines that the request ID included in the received shipping request matches the request ID of a shipping request received in the past for which the status is “3”, the determination unit 160 determines that the received shipping request is a second shipping request (step S802; No). Note that, in this case, shipping requests received in the past for which the status is “3” are first shipping requests.

When the determination unit 160 determines that the received shipping request is a first shipping request (step S802; Yes), the determiner 120 determines the first processing deadline (step S803). In one example, when the received date and time of the received shipping request is from 0:00 to 14:00, the determiner 120 sets the first processing deadline to the present day, and when the received date and time is from 14:00 to 24:00, sets the first processing deadline to the next day.

Then, the determiner 120 registers the determined first processing deadline in the shipping request table T1 illustrated in the example of FIG. 10 (step S804). Then, the outputter 130 outputs the shipping command illustrated in the example of FIG. 5 (step S805). Thereafter, the processing of step S801 is executed.

Next, when the reception unit 140 receives, from the warehouse user, a failure report such as illustrated in the example of FIG. 6 (step S801; Yes), the sender 150 sends, to the sales management device 102, a first failure response expressing the actual inventory count related to the received failure report and that the processing of the first shipping request has failed (step S806).

Next, the sender 150 registers the content of the sent first failure response in the DB 170 (step S807). Specifically, the sender 150 accesses the shipping request table T1 illustrated in the example of FIG. 10, and overwrites the shippable count and the status of the corresponding record. In one example, when the received failure report is for the first shipping request of row number #1 such as illustrated in the example of FIG. 6, the shippable count specified in the failure report is written and the status is overwritten to “3” as in the record of row number #3. Thereafter, the processing of step S801 is executed.

Next, a case is described in which step S802 is executed and the shipping request received by the receiver 110 is a second shipping request. When the determination unit 160 determines that the received shipping request is a second shipping request (step S802; No), the determination unit 160 further determines whether the content of the second shipping request is appropriate (step S808). Specifically, the determination unit 160 determines whether the item related to the first shipping request and the item related to the second shipping request match, and whether the second shipping count is less than or equal to the actual inventory count (shippable count).

When the determination unit 160 determines that the content of the second shipping request is appropriate (step S808; Yes), the determiner 120 determines the second processing deadline (step S809). In this case, if a time margin from the second received date and time at which the second shipping request is received to the first processing deadline is longer than a predetermined reference (for example, six hours), the determiner 120 may be configured to determine the second processing deadline so as to match the first processing deadline. Additionally, if the time margin from the second received date and time to the first processing deadline is shorter than the predetermined reference (for example, six hours), the determiner 120 may be configured to determine the second processing deadline in accordance with the second received date and time as in step S803.

Then, the second processing deadline determined by the determination unit 160 is registered in the DB 170 (step S810). The outputter 130 outputs the second command (step S811). The flow from step S810 to step S811 is the same as the flow from step S804 to step S805. Thereafter, the processing of step S801 is executed.

Meanwhile, when the determination unit 160 determines that the content of the second shipping request is not appropriate, that is, determines that the item related to the first shipping request and the item related to the second shipping request do not match or that the second shipping count is not less than or equal to the actual inventory count (shippable count) (step S808; No), the sender 150 sends an error response to the sales management device 102 (step S812). The error response expresses the request ID and that the item related to the second shipping count or the second shipping count is not appropriate. Thereafter, the processing of step S801 is executed.

Next, when the reception unit 140 receives, from the warehouse user, a completion report reporting that the processing of the shipping request is complete (step S801; Yes), the sender 150 sends, to the sales management device 102, a complete response expressing that the processing of the shipping request related to the received completion report is successful (step S813). Then, the sender 150 registers the content of the sent complete response in the DB 170 (step S814). Specifically, the sender 150 accesses the shipping request table T1 illustrated in the example of FIG. 10, and overwrites the status of the corresponding record. In one example, when the received completion report is for the first shipping request of row number #1 such as illustrated in the example of FIG. 6, the status is overwritten to “2” as in the record of row number #2. Thereafter, the processing of step S801 is executed.

When an event other than the events described above occurs (step S801; Yes), the shipping management device 101 executes a corresponding processing (step S815). Thereafter, the processing of step S801 is executed.

### Sales Management Processing

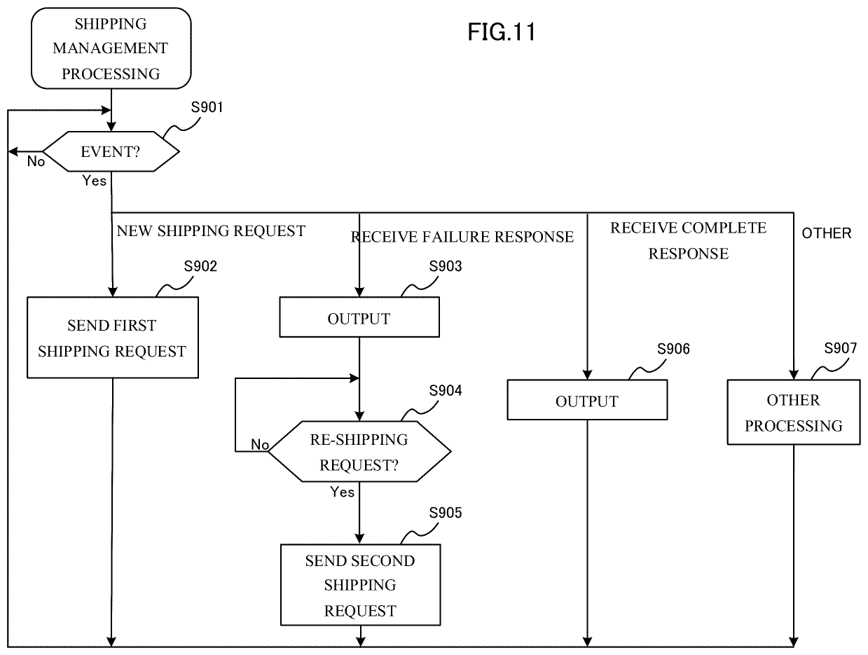

FIG. 11 is a flowchart explaining the flow of sales management processing executed by the sales management device 102 in the present embodiment. The sales management device 102 receives shipping requests from the vendor user, outputs results for the received shipping requests, and the like. Hereinafter, a description is given while referencing FIG. 11.

In one example, the sales management processing starts when the power of the sales management device 102 is turned ON. When the sales management processing starts, the sales management device 102 determines whether an event has occurred (step S901). The sales management processing assumes a stand-by state until an event occurs (step S901; No).

Firstly, when the sales reception unit 210 of the sales management device 102 receives a new shipping request (first shipping request) (step S901; Yes), the sales sender 220 sends, to the shipping management device 101, a first shipping request in which the first item and the first shipping count specified in the new shipping request are specified (step S902). At this time, the sales sender 220 may further specify the request ID. Thereafter, the processing of step S901 is executed.

Next, when the sales receiver 230 receives a first failure response from the shipping management device 101 (step S901; Yes), the sales management device 102 outputs the failure report screen 600 illustrated in the example of FIG. 7 (step S903). Then, the sales reception unit 210 determines whether a re-shipping request is received, that is, whether the re-request button 620 of the failure report screen 600 is selected and the re-request button 740 is selected after the required information is input in the re-request screen 700 illustrated in the example of FIG. 8 (step S904).

A configuration is possible in which, in the re-request screen 700, the first item is specified in the item 720 and it is not possible to input, in the shipping count (second shipping count) 730, a value larger than the actual inventory count from the failure report screen 600. That is, the sales reception unit 210 specifies the first item as the item related to the second shipping request, and receives, from the user, a numerical value that is less than or equal to the actual inventory count as the second shipping count. The processing assumes a stand-by state until a determination is made that the sales reception unit 210 has received a re-shipping request (step S904; No).

When a determination is made that the sales reception unit 210 has received a re-shipping request (second shipping request) (step S904; Yes), the sales sender 220 sends, to the shipping management device 101, a second shipping request in which the first item and the second shipping count that is less than or equal to the actual inventory count specified in the first failure response are specified (step S905). When sending the second shipping request, the sales sender 220 may specify the same request ID as the first shipping request, that is, the request ID specified in the first failure response. Thereafter, the processing of step S901 is executed.

Next, when the sales receiver 230 receives a complete response from the shipping management device 101 (step S901; Yes), the sales management device 102 outputs the content of the complete response (step S906). Thereafter, the processing of step S901 is executed.

When an event other than the events described above occurs (step S901; Yes), the shipping management device 102 executes a corresponding processing (step S907). Thereafter, the processing of step S901 is executed.

According to the present embodiment described above, in a case in which a shipping request from the vendor user cannot be fulfilled due to insufficient inventory of an item, the warehouse user sends the first failure response and the vendor user can issue a re-shipping request on the basis of that first failure response. As a result, the work by the vendor user to create a new shipping request can be eliminated, and processing such as shipping only a portion of the desired number of items, canceling the shipping request, and the like can be performed smoothly and quickly.

### Modified Examples

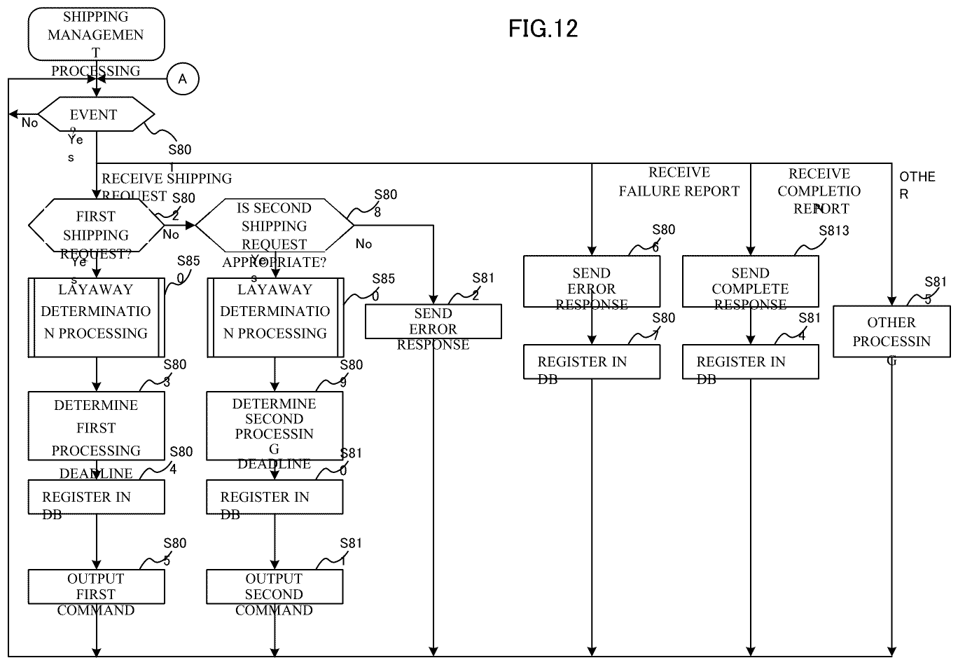

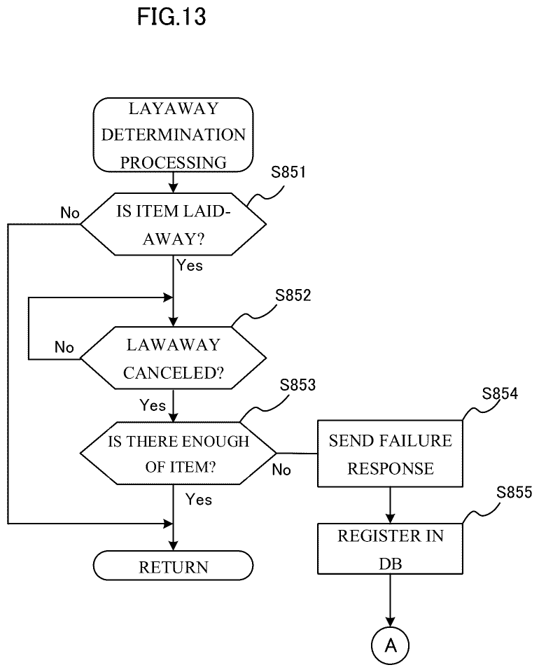

In the embodiment described above, another shipping request may be received during the period from when the first failure response is sent due to insufficient inventory of a certain item to when the second shipping request is received. As such, a configuration is possible in which, as illustrated in FIG. 12, in a step after the shipping request of the shipping management processing is received, layaway determination processing for laying away an item waiting for a second shipping request is executed (step S850). Here, the term “layaway” refers to holding, for a certain amount of time, an item waiting for a second shipping request (layaway item) so as not be shipped due to another shipping request. That is, the determination unit 160 suspends the processing when the receiver 110 receives, within a predetermined amount of time after the sender 150 sends the first failure response, a shipping request, which is a shipping request related to the first item, other than a second shipping request in response to the first failure response. Hereinafter, a description is given while referencing FIG. 13.

The layaway determination processing starts after, in the shipping management processing, the determination unit 160 determines that the received shipping request is a first shipping request (after a determination of Yes in step S802), and after the determination unit 160 determines that the content of the second shipping request is appropriate (after a determination of Yes in step S808).

When the layaway determination processing starts, the determination unit 160 references the item table T2 stored in the DB 170, and determines whether the item related to the received shipping request is a lay-away item (step S851).

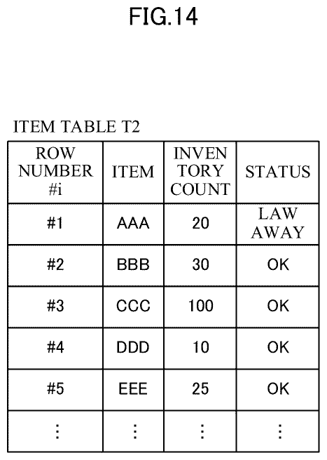

FIG. 14 is an explanatory drawing illustrating an example of the item table. The item table T2 includes a row number #i, an item, an inventory count, and a status. The row number #i indicates the row number of the item table T2. The item indicates the item stored in the warehouse. The inventory count indicates the inventory count of the item and, for example, is counted by registering a received count when receiving the item and registering the shipping count picked every time the warehouse user picks the item for the shipping processing. The status indicates, for each item, whether that item is in a layaway state or a pickable (OK) state.

During the period in which, after the sender 150 sends the first failure response to the sales management device 102, the status of the shipping request in the shipping request table T1 illustrated in the example of FIG. 10 is “3”, the status of that item in the item table T2 is set to the layaway state. When the second shipping request is received and the status changes to “4”, or when the predetermined amount of time elapses without receiving a second shipping request and the status changes to “5”, the status of that item in the item table T2 is set to the pickable state. Note that this predetermined amount of time may be a predetermined certain amount of time. Additionally, this predetermined amount of time may be determined on the basis of a statistical distribution of the amount of time from when the sender 150 sends the first failure response to when the receiver 110 receives the second shipping request. For example, this predetermined amount of time may be an amount of time in which 90% of the statistical distribution of time, from when the sender 150 sends the first failure response to when the receiver 110 receives the second shipping request, falls.

When the determination unit 160 determines that the item related to the received shipping request is not a lay-away item (step S851; No), the processing returns to the shipping management processing illustrated in FIG. 12. Returning to FIG. 13, when the determination unit 160 determines that the item related to the received shipping request is a lay-away item (step S851; Yes), the determination unit 160 monitors the item table T2 and further determines whether the layaway state has been canceled (step S852). The determination unit 160 assumes a stand-by state until the layaway state is canceled (step S852; No).

When the determination unit 160 determines that the layaway state is canceled (step S852; Yes), the determination unit 160 further determines whether there is enough of the item related to the received shipping request, that is, whether the inventory count registered in the item table T2 is greater than or equal to the shipping count related to the received shipping request (step S853). When the determination unit 160 determines that there is enough of the item related to the received shipping request (step S853; Yes), the processing returns to the shipping management processing illustrated in FIG. 12.

Returning to FIG. 13, when the determination unit 160 determines that there is not enough of the item related to the received shipping request (step S853; No), the sender 150 sends the first failure response to the sales management device 102 (step S854). Then, the sender 150 accesses the shipping request table T1 stored in the DB 170 and changes the status of the corresponding shipping request to “3”. Thereafter, the processing continues to “A” illustrated in the example of FIG. 12.

In the modified examples, while waiting for the second shipping request for a certain item, the item is laid-away for a certain amount of time even if another shipping request is received. As such, it is possible to avoid trouble such as inventory becoming even more insufficient while waiting for the second shipping request and, consequently, not being able to fulfill the re-shipping request.

### APPENDICES

### Appendix 1

A shipping management device connected to a sales management device via a network, the shipping management device comprising:
one or more processors, wherein
the one or more processors
   receive, from the sales management device, a first shipping request in which a first item and a first shipping count are specified,
   determine a first processing deadline in accordance with a first received date and time at which the first shipping request is received,
   output a first command indicating that the first shipping count is to be shipped from an inventory of the first item by the determined first processing deadline,
   in a case in which the first command cannot be fulfilled due to the actual inventory count being less than the specified first shipping count,
      receive, from a user, a failure report including the actual inventory count and
      send, to the sales management device, a first failure response expressing the actual inventory count related to the received failure report and that processing of the first shipping request has failed, and
   in a case in which the one or more processors receive, from the sales management device, a second shipping request in response to the first failure response, the first item and a second shipping count less than or equal to the actual inventory count being specified in the second shipping request,
      the one or more processors set a second processing deadline to match the first processing deadline in cases in which a time margin from a second received date and time at which the second shipping request is received to the determined first processing deadline is longer than a predetermined reference, and set the second processing deadline to the second received date and time in cases in which the time margin is not longer than the predetermined reference, and
      the one or more processors outputs a second command indicating that the second shipping count is to be shipped from the inventory of the first item by the set second processing deadline.

### Appendix 2

The shipping management device according to appendix 1, wherein
a request ID is further specified in the first shipping request and the second shipping request, and
the one or more processors
   in a case in which the request ID of the first shipping request matches the request ID of the second shipping request, further determine that the second shipping request is in response to the first failure response, and set the second processing deadline related to the determined second shipping request.

### Appendix 3

The shipping management device according to appendix 2, wherein
the one or more processors
   in a case in which the request ID of the first shipping request and the request ID of the second shipping request match, further determine whether an item of the first shipping request and an item of the second shipping request match and the second shipping count is less than or equal to the actual inventory count, and
   in a case in which the one or more processors determine that the request ID of the first shipping request and the request ID of the second shipping request match but the second shipping count is not less than or equal to the actual inventory count, send, to the sales management device, an error response expressing the request ID and that the second shipping count related to the second shipping request is not appropriate.

### Appendix 4

The shipping management device according to appendix 2 or 3, wherein the one or more processors suspend processing in a case in which, within a predetermined amount of time after the first failure response is sent, a shipping request which is a shipping request related to the first item, other than the second shipping request in response to the first failure response, is received.

### Appendix 5

The shipping management device according to appendix 4, wherein the predetermined amount of time is a predetermined certain amount of time.

### Appendix 6

The shipping management device according to appendix 2, wherein the predetermined amount of time is determined based on a statistical distribution of an amount of time from when the one or more processors receives the first failure response to when the second shipping request is received.

### Appendix 7

A sales management device connected to a shipping management device via a network, the sales management device comprising:
one or more processors, wherein
the one or more processors
   receive, from a user, a first shipping request in which a first item and a first shipping count are specified,
   send, to the shipping management device, the received first shipping request, and
   receive, from the shipping management device, a first failure response expressing an actual inventory count that is less than the specified first shipping count and that processing of the first shipping request has failed,
the one or more processors further receive, from a user, a second shipping request in response to the received first failure response, the first item and a second shipping count less than or equal to the actual inventory count being specified in the second shipping request, and
the one or more processors further send the received second shipping request to the shipping management device.

### Appendix 8

The sales management device according to appendix 7, wherein
a request ID is further specified in each shipping request, and
the one or more processors
   in a case of sending the second shipping request, specify a request ID identical to that of the first shipping request.

### Appendix 9

The sales management device according to appendix 8, wherein the one or more processors specify the first item as an item related to the second shipping request, and receive, from the user, a numerical value that is less than or equal to the actual inventory count as the second shipping count.

### Appendix 10

A shipping management method in which a shipping management computer connected to a sales management computer via a network
receives, from the sales management computer, a first shipping request in which a first item and a first shipping count are specified;
determines a first processing deadline in accordance with a first received date and time at which the first shipping request is received;
outputs a first command indicating that the first shipping count is to be shipped from an inventory of the first item by the determined first processing deadline;
in a case in which the first command cannot be fulfilled due to the actual inventory count being less than the specified first shipping count,
   receives, from a user, a failure report including the actual inventory count and
   sends, to the sales management computer, a first failure response expressing the actual inventory count related to the received failure report and that processing of the first shipping request has failed; and
in a case of receiving, from the sales management computer, a second shipping request in response to the first failure response, the first item and a second shipping count less than or equal to the actual inventory count being specified in the second shipping request,
   sets the second processing deadline is set to match the first processing deadline in cases in which a time margin from a second received date and time at which the second shipping request is received to the determined first processing deadline is longer than a predetermined reference, and set the second processing deadline to the second received date and time in cases in which the time margin is not longer than the predetermined reference, and
   outputs a second command indicating that the second shipping count is to be shipped from the inventory of the first item by the set second processing deadline.

### Appendix 11

A sales management method in which a sales management computer connected to a shipping management computer via a network
receives, from a user, a first shipping request in which a first item and a first shipping count are specified;
sends, to the shipping management computer, the received first shipping request;
receives, from the shipping management computer, a first failure response expressing an actual inventory count that is less than the specified first shipping count and that processing of the first shipping request has failed;
further receives, from a user, a second shipping request in response to the received first failure response, the first item and a second shipping count less than or equal to the actual inventory count being specified in the second shipping request; and
further sends the received second shipping request to the shipping management computer.

### Appendix 12

A computer-readable recording medium storing a program that causes a shipping management computer connected to a sales management computer via a network to execute processing of:
receiving, from the sales management computer, a first shipping request in which a first item and a first shipping count are specified;
determining a first processing deadline in accordance with a first received date and time at which the first shipping request is received;
outputting a first command indicating that the first shipping count is to be shipped from an inventory of the first item by the determined first processing deadline;
in a case in which the first command cannot be fulfilled due to the actual inventory count being less than the specified first shipping count,
   receiving, from a user, a failure report including the actual inventory count and
   sending, to the sales management computer, a first failure response expressing the actual inventory count related to the received failure report and that processing of the first shipping request has failed; and
in a case in which the shipping management computer receives, from the sales management computer, a second shipping request in response to the first failure response, the first item and a second shipping count less than or equal to the actual inventory count being specified in the second shipping request,
   setting the second processing deadline to match the first processing deadline in cases in which a time margin from a second received date and time at which the second shipping request is received to the determined first processing deadline is longer than a predetermined reference, and setting the second processing deadline to the second received date and time in cases in which the time margin is not longer than the predetermined reference, and
   outputting a second command indicating that the second shipping count is to be shipped from the inventory of the first item by the set second processing deadline.

### Appendix 13

A computer-readable recording medium storing a program that causes a sales management computer connected to a shipping management computer via a network to execute processing of:
receiving, from a user, a first shipping request in which a first item and a first shipping count are specified;
sending, to the shipping management computer, the received first shipping request;
receiving, from the shipping management computer, a first failure response expressing an actual inventory count that is less than the specified first shipping count and that processing of the first shipping request has failed;
further receiving, by the sales management computer and from a user, a second shipping request in response to the received first failure response, the first item and a second shipping count less than or equal to the actual inventory count being specified in the second shipping request; and
further sending, by the sales management computer, the received second shipping request to the shipping management computer.

The foregoing describes some example embodiments for explanatory purposes.

Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

The present disclosure can be advantageously applied to a shipping management device, a sales management device, a shipping management method, a sales management method, and a non-transitory recording medium that, when an item in a warehouse has insufficient inventory, assist the smooth and expedited performance of processing for shipping only a portion of the desired number of items.

1. A shipping management device connected to a sales management device via a network, the shipping management device comprising:
one or more processors, wherein
the one or more processors
receive, from the sales management device, a first shipping request in which a first item and a first shipping count are specified,
determine a first processing deadline in accordance with a first received date and time at which the first shipping request is received,
output a first command indicating that the first shipping count is to be shipped from an inventory of the first item by the determined first processing deadline,
in a case in which the first command cannot be fulfilled due to the actual inventory count being less than the specified first shipping count,
receive, from a user, a failure report including the actual inventory count and
send, to the sales management device, a first failure response expressing the actual inventory count related to the received failure report and that processing of the first shipping request has failed, and
in a case in which the one or more processors receive, from the sales management device, a second shipping request in response to the first failure response, the first item and a second shipping count less than or equal to the actual inventory count being specified in the second shipping request,
the one or more processors set a second processing deadline to match the first processing deadline in cases in which a time margin from a second received date and time at which the second shipping request is received to the determined first processing deadline is longer than a predetermined reference, and set the second processing deadline to the second received date and time in cases in which the time margin is not longer than the predetermined reference, and
the one or more processors outputs a second command indicating that the second shipping count is to be shipped from the inventory of the first item by the set second processing deadline.

2. The shipping management device according to claim 1, wherein
a request ID is further specified in the first shipping request and the second shipping request, and
the one or more processors
in a case in which the request ID of the first shipping request matches the request ID of the second shipping request, further determine that the second shipping request is in response to the first failure response, and set the second processing deadline related to the determined second shipping request.

3. The shipping management device according to claim 2, wherein
the one or more processors
in a case in which the request ID of the first shipping request and the request ID of the second shipping request match, further determine whether an item of the first shipping request and an item of the second shipping request match and the second shipping count is less than or equal to the actual inventory count, and
in a case in which the one or more processors determine that the request ID of the first shipping request and the request ID of the second shipping request match but the second shipping count is not less than or equal to the actual inventory count, send, to the sales management device, an error response expressing the request ID and that the second shipping count related to the second shipping request is not appropriate.

4. The shipping management device according to claim 2, wherein the one or more processors suspend processing in a case in which, within a predetermined amount of time after the first failure response is sent, a shipping request which is a shipping request related to the first item, other than the second shipping request in response to the first failure response, is received.

5. The shipping management device according to claim 4, wherein the predetermined amount of time is a predetermined certain amount of time.

6. The shipping management device according to claim 2, wherein the predetermined amount of time is determined based on a statistical distribution of an amount of time from when the one or more processors receives the first failure response to when the second shipping request is received.

7. A sales management device connected to a shipping management device via a network, the sales management device comprising:
one or more processors, wherein
the one or more processors
receive, from a user, a first shipping request in which a first item and a first shipping count are specified,
send, to the shipping management device, the received first shipping request, and
receive, from the shipping management device, a first failure response expressing an actual inventory count that is less than the specified first shipping count and that processing of the first shipping request has failed,
the one or more processors further receive, from a user, a second shipping request in response to the received first failure response, the first item and a second shipping count less than or equal to the actual inventory count being specified in the second shipping request, and
the one or more processors further send the received second shipping request to the shipping management device.

8. The sales management device according to claim 7, wherein
a request ID is further specified in each shipping request, and
the one or more processors
in a case of sending the second shipping request, specify a request ID identical to that of the first shipping request.

9. The sales management device according to claim 8, wherein the one or more processors specify the first item as an item related to the second shipping request, and receive, from the user, a numerical value that is less than or equal to the actual inventory count as the second shipping count.

10. A shipping management method in which a shipping management computer connected to a sales management computer via a network
receives, from the sales management computer, a first shipping request in which a first item and a first shipping count are specified;
determines a first processing deadline in accordance with a first received date and time at which the first shipping request is received;
outputs a first command indicating that the first shipping count is to be shipped from an inventory of the first item by the determined first processing deadline;
in a case in which the first command cannot be fulfilled due to the actual inventory count being less than the specified first shipping count,
receives, from a user, a failure report including the actual inventory count and
sends, to the sales management computer, a first failure response expressing the actual inventory count related to the received failure report and that processing of the first shipping request has failed; and
in a case of receiving, from the sales management computer, a second shipping request in response to the first failure response, the first item and a second shipping count less than or equal to the actual inventory count being specified in the second shipping request,
sets the second processing deadline is set to match the first processing deadline in cases in which a time margin from a second received date and time at which the second shipping request is received to the determined first processing deadline is longer than a predetermined reference, and set the second processing deadline to the second received date and time in cases in which the time margin is not longer than the predetermined reference, and
outputs a second command indicating that the second shipping count is to be shipped from the inventory of the first item by the set second processing deadline.

11. A sales management method in which a sales management computer connected to a shipping management computer via a network
receives, from a user, a first shipping request in which a first item and a first shipping count are specified;
sends, to the shipping management computer, the received first shipping request;
receives, from the shipping management computer, a first failure response expressing an actual inventory count that is less than the specified first shipping count and that processing of the first shipping request has failed;
further receives, from a user, a second shipping request in response to the received first failure response, the first item and a second shipping count less than or equal to the actual inventory count being specified in the second shipping request; and
further sends the received second shipping request to the shipping management computer.

12. A computer-readable recording medium storing a program that causes a shipping management computer connected to a sales management computer via a network to execute processing of:
receiving, from the sales management computer, a first shipping request in which a first item and a first shipping count are specified;
determining a first processing deadline in accordance with a first received date and time at which the first shipping request is received;
outputting a first command indicating that the first shipping count is to be shipped from an inventory of the first item by the determined first processing deadline;
in a case in which the first command cannot be fulfilled due to the actual inventory count being less than the specified first shipping count,
receiving, from a user, a failure report including the actual inventory count and
sending, to the sales management computer, a first failure response expressing the actual inventory count related to the received failure report and that processing of the first shipping request has failed; and
in a case in which the shipping management computer receives, from the sales management computer, a second shipping request in response to the first failure response, the first item and a second shipping count less than or equal to the actual inventory count being specified in the second shipping request,
setting the second processing deadline to match the first processing deadline in cases in which a time margin from a second received date and time at which the second shipping request is received to the determined first processing deadline is longer than a predetermined reference, and setting the second processing deadline to the second received date and time in cases in which the time margin is not longer than the predetermined reference, and
outputting a second command indicating that the second shipping count is to be shipped from the inventory of the first item by the set second processing deadline.

13. A computer-readable recording medium storing a program that causes a sales management computer connected to a shipping management computer via a network to execute processing of:
receiving, from a user, a first shipping request in which a first item and a first shipping count are specified;
sending, to the shipping management computer, the received first shipping request;
receiving, from the shipping management computer, a first failure response expressing an actual inventory count that is less than the specified first shipping count and that processing of the first shipping request has failed;
further receiving, by the sales management computer and from a user, a second shipping request in response to the received first failure response, the first item and a second shipping count less than or equal to the actual inventory count being specified in the second shipping request; and
further sending, by the sales management computer, the received second shipping request to the shipping management computer.
